(19) United States
(12) Patent Application Publication
(10) Pub. No.: US 2017/0253084 A1
(43) Pub. Date: Sep. 7, 2017

(54) NON-PNEUMATIC TIRE

(71) Applicant: BRIDGESTONE CORPORATION, Tokyo (JP)

(72) Inventors: Narumi TAKAHASHI, Tokyo (JP); Akihiko ABE, Tokyo (JP)

(73) Assignee: BRIDGESTONE CORPORATION, Tokyo (JP)

(21) Appl. No.: 15/501,069

(22) PCT Filed: Jun. 10, 2015
(86) PCT No.: PCT/JP2015/066757

§ 371 Date: Feb. 1, 2017

(30) Foreign Application Priority Data
Aug. 8, 2014 (JP) 2014-163025

(51) Int. Cl. B60C 7/26; B60C 7/10

(52) U.S. Cl. CPC B60C 7/26; B60C 7/102; B60C 7/24

(57) ABSTRACT

The present invention is provided with: a mounting body mounted on an axle; a ring-shaped body (13) surrounding the mounting body from an outside in a tire radial direction; a connecting member (15) configured to connect the mounting body and the ring-shaped body (13) such that the mounting body and the ring-shaped body (13) are displaceable; and a cylindrical tread member (16) mounted over the ring-shaped body (13), wherein grooves (51, 52) are formed at an outer peripheral surface of a portion located above and corresponding to a portion of the tread member (16) at which the ring-shaped body (13) and the connecting member (15) are connected.

### TECHNICAL FIELD

The present invention relates to a non-pneumatic tire which does not need to be filled with pressurized air when the tire is used.

Priority is claimed on Japanese Patent Application No. 2014-163025, filed Aug. 8, 2014, the content of which is incorporated herein by reference.

### BACKGROUND ART

The occurrence of a puncture of a pneumatic tire which has an inside thereof filled with pressurized air and is used in a related art is an inevitable problem in terms of a structure thereof.

In order to solve such a problem, in recent years, for example, the non-pneumatic tire disclosed in Patent Document 1 including a mounting body mounted on an axle, a ring-shaped body surrounding the mounting body from an outside in a tire radial direction, a connecting member configured to connect the mounting body and the ring-shaped body so that the mounting body and the ring-shaped body are displaceably connected, and a cylindrical tread member mounted over the ring-shaped body has been suggested.

### DOCUMENT OF RELATED ART

### Patent Document

### Patent Document 1

### Japanese Unexamined Patent Application, First Publication No. 2013-86712

### SUMMARY OF INVENTION

### Technical Problem

However, in the non-pneumatic tire in the related art, portions of a tread member at which local a ground contact pressure is increased occur, and thus the tread member is likely to be subject to uneven wear.

The present invention was made in view of the above-described circumstances, and the present invention is for the purpose of providing a non-pneumatic tire capable of minimizing and equalizing variation of a magnitude of a ground contact pressure occurring at a tread member, and thus capable of suppressing uneven wear of the tread member.

### Solution to Problem

A non-pneumatic tire of the present invention includes: a mounting body mounted on an axle; a ring-shaped body surrounding the mounting body from an outside in a tire radial direction; a connecting member configured to connect the mounting body and the ring-shaped body such that the mounting body and the ring-shaped body are displaceable; and a cylindrical tread member mounted over the ring-shaped body, wherein grooves are formed at an outer peripheral surface of a portion located above and corresponding to a portion of the tread member at which the ring-shaped body and the connecting member are connected.

Also, a non-pneumatic tire of the present invention includes: a mounting body mounted on an axle; a ring-shaped body surrounding the mounting body from an outside in a tire radial direction; a connecting member configured to connect the mounting body and the ring-shaped body such that the mounting body and the ring-shaped body are displaceable; and a cylindrical tread member mounted over the ring-shaped body, wherein an outer peripheral surface of the tread member is formed in a shape protruding outward in the tire radial direction in a cross-sectional view in a tire width direction, and grooves are formed at an outer peripheral surface of a top part of the tread member which is located closest to an outer side in the tire radial direction.

### Effects of Invention

According to a non-pneumatic tire of the present invention, variation of a magnitude of a ground contact pressure occurring at a tread member can be minimized and equalized, and thus uneven wear of the tread member can be limited.

### BRIEF DESCRIPTION OF DRAWINGS

FIG. 1 is a view showing a first embodiment of a non-pneumatic tire related to the present invention and is a schematic exploded perspective view in which a portion of the non-pneumatic tire is disassembled.

FIG. 2 is a side view when the non-pneumatic tire shown in FIG. 1 is viewed from a first side in a tire width direction.

FIG. 3 is an enlarged view showing a main part of FIG. 2.

FIG. 4 is a plan view when a connecting member shown in FIG. 3 is viewed from a tire circumferential direction.

FIG. 5 is a perspective view showing a state in which a portion, at which a mounting body of the non-pneumatic tire shown in FIG. 2 is omitted, is cut in the tire width direction.

FIG. 6 is a side view when a first divided case body of the non-pneumatic tire shown in FIG. 1 is viewed from a first side in the tire width direction or a side view when a second divided case body thereof is viewed from a second side in the tire width direction.

FIG. 7 is an enlarged view showing a main part of FIG. 5.

FIG. 8 is a view showing a modified example of a tread member of the first embodiment.

FIG. 9 is a view showing another modified example of the tread member of the first embodiment.

FIG. 10 is a view showing a second embodiment of the non-pneumatic tire related to the present invention and is a schematic exploded perspective view in which a portion of the non-pneumatic tire is disassembled.

FIG. 11 is a view showing a main part of FIG. 10 and is a view corresponding to FIG. 7.

### Description of Embodiments

Hereinafter, an embodiment related to the present invention will be described with reference to the drawings.

### First Embodiment

### (Constitution of Non-Pneumatic Tire)

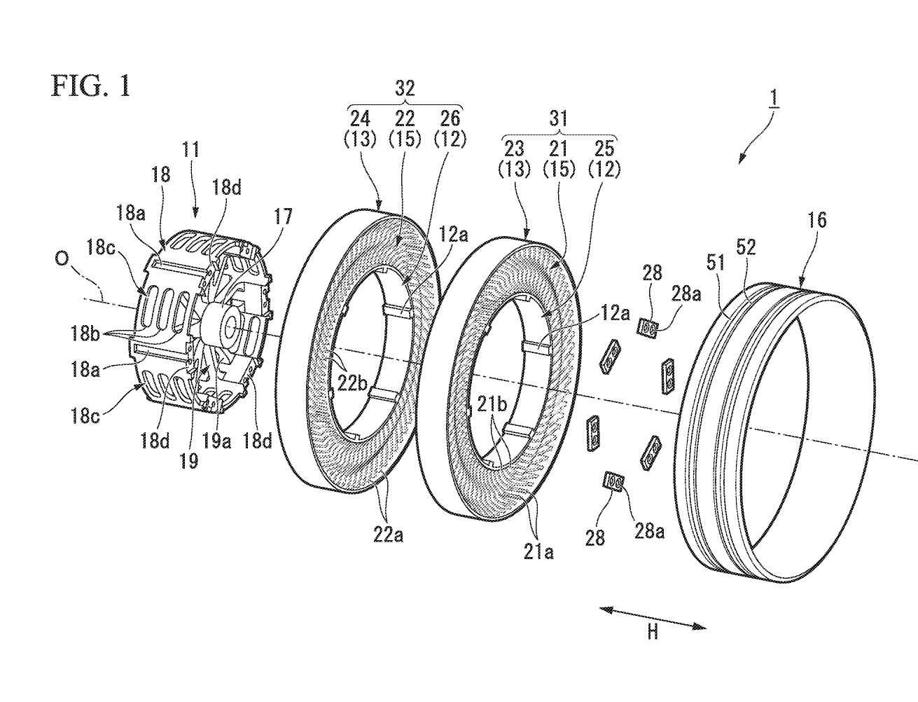

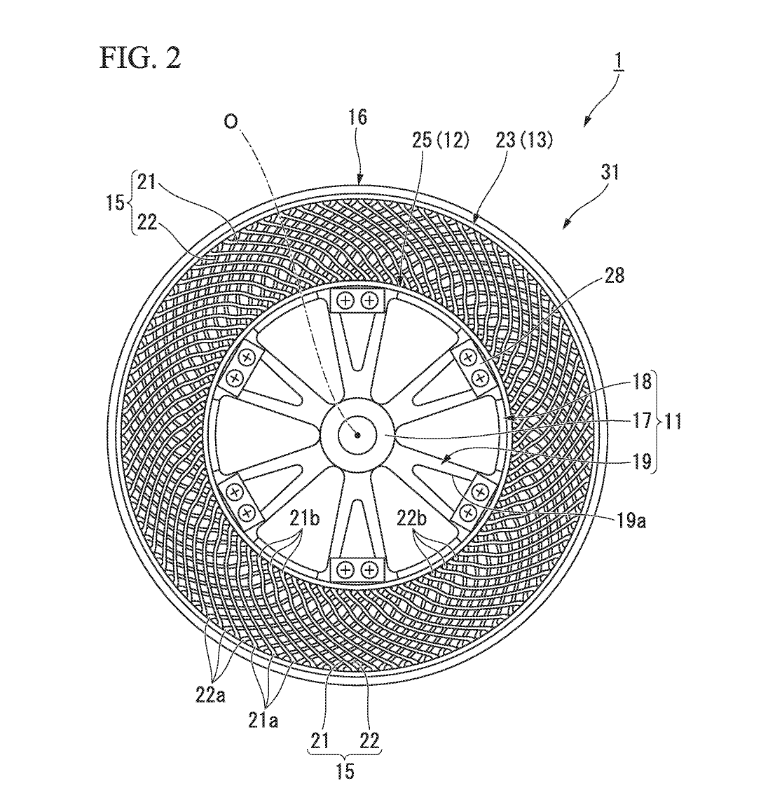

As shown in FIGS. 1 and 2, a non-pneumatic tire 1 of this embodiment includes a mounting body 11 mounted on an axle (not shown), a cylindrical ring-shaped body 13 surrounding the mounting body 11 from an outside in a tire radial direction, a plurality of connecting members 15 arranged between the mounting body 11 and the ring-shaped body 13 in a tire circumferential direction and configured to connect the mounting body 11 and the ring-shaped body 13 such that the mounting body 11 and the ring-shaped body 13 are relatively and elastically displaceable, and a cylindrical tread member 16 mounted over the ring-shaped body 13.

Note that the non-pneumatic tire 1 of this embodiment may be adopted for, for example, a handle type electric wheel chair and the like defined in Japanese Industrial Standards JIS T 9208 and a small vehicle and the like travelling at low speed. Furthermore, a size of the non-pneumatic tire 1 is not particularly limited, but may be, for example, 3.00-8 or the like. The non-pneumatic tire 1 may be adopted for a passenger vehicle. The size thereof in this case is not particularly limited, but may be, for example, 155165R13 or the like.

The mounting body 11, the ring-shaped body 13, and the tread member 16 are arranged coaxially with a common axis. Hereinafter, the common axis is defined as an axis O, a direction along the axis O is defined as a tire width direction H, a direction perpendicular to the axis O is defined as the tire radial direction, and a direction around the axis O is defined as the tire circumferential direction. Note that the mounting body 11, the ring-shaped body 13, and the tread member 16 are arranged in a state in which central portions thereof coincide with each other in the tire width direction H.

The mounting body 11 includes a mounting cylinder part 17 to which a distal end portion of the axle is mounted, an outer ring part 18 surrounding the mounting cylinder part 17 from an outside in the tire radial direction, and a plurality of ribs 19 configured to connect the mounting cylinder part 17 and the outer ring part 18. The mounting cylinder part 17, the outer ring part 18, and the ribs 19 are integrally formed of, for example, a metallic material such as an aluminum alloy. The mounting cylinder part 17 and the outer ring part 18 are formed in a cylindrical shape and are arranged to be coaxial with the axis O. The plurality of ribs 19 are disposed, for example, at equal intervals in the circumferential direction.

A plurality of key grooves 18a inwardly concave in the tire radial direction and extending in the tire width direction H are formed at an outer peripheral surface of the outer ring part 18 at intervals in the tire circumferential direction. In the outer peripheral surface of the outer ring part 18, the key grooves 18a are open only at a first side (an outside of a vehicle body) in the tire width direction H and are closed at a second side (an inside of the vehicle body) in the tire width direction H.

A plurality of weight-reducing holes 18b passing through the outer ring part 18 in the tire radial direction are formed at portions of the outer ring part 18, which are located between the key grooves 18a adjacent to each other in the tire circumferential direction, at intervals in the tire width direction H. A plurality of hole rows 18c constituted by the plurality of weight-reducing holes 18b are formed at intervals in the tire circumferential direction. Similarly, weight-reducing holes 19a passing through the ribs 19 in the tire width direction H are also formed at the ribs 19.

Concave parts 18d into which plate members 28 having through holes 28a formed therein are fitted are formed at positions of an edge of a first side of the outer ring part 18 in the tire width direction H to correspond to the key grooves 18a. The concave parts 18d are concave toward a second side in the tire width direction H. Furthermore, female thread parts communicating with the through holes 28a of the plate members 28 fitted into the concave parts 18d are formed at wall surfaces facing a first side in the tire width direction H among wall surfaces defining the concave parts 18d.

Note that the plurality of through holes 28a are formed at the plate members 28 at intervals in the tire circumferential direction. Similarly, the plurality of female thread parts are formed at the wall surfaces of the concave parts 18d at intervals in the tire circumferential direction. In the shown example, a case in which two through holes 28a and two female thread parts are formed is exemplified, but the numbers of through holes 28a and female thread parts is not limited to two.

A cylindrical exterior body 12 is externally fitted to the mounting body 11. Ridge parts 12a protruding inward in the tire radial direction and extending over an entire length thereof in the tire width direction H are formed at an inner circumferential surface of the exterior body 12. The plurality of ridge parts 12a are formed at the inner circumferential surface of the exterior body 12 at intervals in the tire circumferential direction and are separately engaged with the key grooves 18a formed at the mounting body 11.

Also, the exterior body 12 is fixed to the mounting body 11 by screwing bolts (not shown) through the through holes 28a of the plate members 28 fitted into the concave parts 18d and into the female thread parts in a state in which the ridge parts 12a are engaged with the key grooves 18a.

Note that a pair of a lateral wall surface and a bottom wall surface facing each other in the tire circumferential direction among wall surfaces defining the key grooves 18a are formed such that the pair of the lateral wall surface and the bottom wall surface are orthogonal to each other. Also, a pair of a lateral wall surface rising from the inner circumferential surface of the exterior body 12 and a top wall surface facing inward in the tire radial direction among outer surfaces of the ridge parts 12a are also formed such that the pair of the lateral wall surface and the top wall surface are similarly orthogonal to each other. The sizes of the ridge parts 12a and the key grooves 18a in the tire circumferential direction are the same.

With such a constitution, the ridge parts 12a are precisely fitted into the key grooves 18a so that the ridge parts 12a are engaged with the key grooves 18a with less rattling therein.

The connecting members 15 connect an outer peripheral surface side of the mounting body 11 and an inner circumferential surface side of the ring-shaped body 13 such that the outer peripheral surface side of the mounting body 11 and the inner circumferential surface side of the ring-shaped body 13 are relatively and elastically displaceable. In the shown example, the connecting members 15 include first connecting plates 21 and second connecting plates 22 which connect the outer peripheral surface of the exterior body 12 externally fitted to the mounting body 11 and the inner circumferential surface of the ring-shaped body 13. The first connecting plates 21 and the second connecting plates 22 are plate materials which can be elastically deformed together.

The plurality of first connecting plates 21 are disposed in the tire circumferential direction at positions of the first side in the tire width direction H. The plurality of second connecting plates 22 are disposed in the tire circumferential direction at positions of the second side in the tire width direction H. In other words, the first connecting plates 21 and the second connecting plates 22 are disposed at intervals in the tire width direction H, and the plurality of first connecting plates 21 and the plurality of second connecting plates 22 are disposed in the tire circumferential direction at their respective positions. For example, 60 first connecting plates 21 and 60 second connecting plates 22 are provided in the tire circumferential direction.

The plurality of connecting members 15 are separately disposed at positions between the exterior body 12 and the ring-shaped body 13 to be rotationally symmetrical with respect to the axis O. All of the connecting members 15 are set to be the same shape and size, and a width of the connecting members 15 in the tire width direction H are smaller than a width of the ring-shaped body 13 in the tire width direction H.

Also, the first connecting plates 21 adjacent to each other in the tire circumferential direction are not in contact with each other. Similarly, the second connecting plates 22 adjacent to each other in the tire circumferential direction are not in contact with each other. The first connecting plates 21 and the second connecting plates 22 adjacent to each other in the tire width direction H are not in contact with each other either. The first connecting plates 21 and the second connecting plates 22 have the same width and thickness in the tire width direction H.

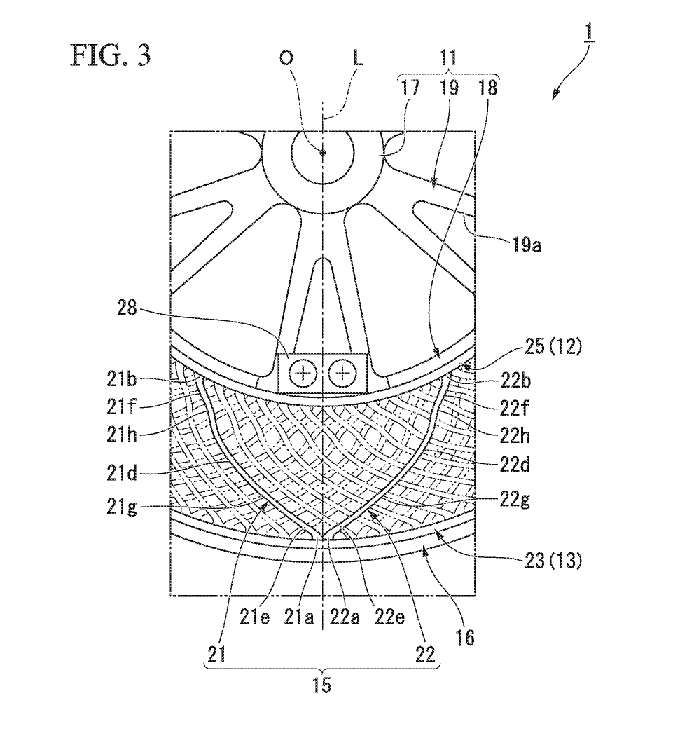

As shown in FIG. 3, first ends (outer ends) 21a of the first connecting plates 21 connected to the ring-shaped body 13 are located closer to first side in the tire circumferential direction than the second ends (inner ends) 21b connected to the exterior body 12. On the other hand, first ends (outer ends) 22a of the second connecting plates 22 connected to the ring-shaped body 13 are located closer to the second side in the tire circumferential direction than the second ends (inner ends) 22b connected to the exterior body 12.

Also, the first ends 21a and 22a of the first connecting plates 21 and the second connecting plates 22 constituting one connecting member 15 are connected at positions of the inner circumferential surface of the ring-shaped body 13 which are different in the tire width direction H but the same in the tire circumferential direction.

A plurality of curved parts 21d to 21f and 22d to 22f curved in the tire circumferential direction are formed at intermediate portions of the first connecting plates 21 and the second connecting plates 22 which are located between the first ends 21a and 22a and the second ends 21b and 22b.

The plurality of curved parts 21d to 21f and 22d to 22f are formed in an extension direction along which the first connecting plates 21 and the second connecting plates 22 extend in a side view of the tire when the non-pneumatic tire 1 is viewed in the tire width direction H. In the shown example, the plurality of curved parts 21d to 21f of the first connecting plates 21 and the plurality of curved parts 22d to 22f of the second connecting plates 22 are adjacent to each other in the above-described extension direction, and curved directions thereof are opposite to each other.

The plurality of curved parts 21d to 21f formed at the first connecting plates 21 have the first curved parts 21d curved to project toward the second side in the tire circumferential direction, the second curved parts 21e located between the first curved parts 21d and the first ends 21a and curved to project toward a first side in the tire circumferential direction, and third curved parts 21f located between the first curved parts 21d and the second ends 21b and curved to project toward the first side in the tire circumferential direction. The second curved parts 21e are continuous with the first ends 21a.

The plurality of curved parts 22d to 22f formed at the second connecting plates 22 have the first curved parts 22d curved to project toward the first side in the tire circumferential direction, the second curved parts 22e located between the first curved parts 22d and the first ends 22a and curved to project toward the second side in the tire circumferential direction, and the third curved parts 22f located between the first curved parts 22d and the second ends 22b and curved to project toward the second side in the tire circumferential direction. The second curved parts 22e are continuous with the first ends 22a.

In the shown example, radii of curvatures of the first curved parts 21d and 22d in the side view of the tire are formed to be larger than those of the second curved parts 21e and 22e and the third curved parts 21f and 22f, and the first curved parts 21d and 22d are disposed at central portions in extension directions of the first connecting plates 21 and the second connecting plates 22.

Lengths of the first connecting plates 21 and the second connecting plates 22 are the same. The second ends 21b and 22b of the first connecting plates 21 and the second connecting plates 22 are separately connected from positions of the outer peripheral surface of the exterior body 12 which are opposite to the first ends 21a and 22a in the tire radial direction to positions of the first side and the second sides about the axis O which are the same distance away from the axis O in the tire circumferential direction in the side view of the tire.

To be specific, the second ends 21b and 22b of the first connecting plates 21 and the second connecting plates 22 are connected to the outer peripheral surface of the exterior body 12 such that angles formed by lines connecting the first ends 21a and the second ends 21b of the first connecting plates 21 and lines connecting the first ends 22a and the second ends 22b of the second connecting plates 22 have, for example, angles of 20° or more and 135° or less.

Also, directions in which the first curved parts 21d and 22d, the second curved parts 21e and 22e, and the third curved parts 21f and 22f of the first connecting plates 21 and the second connecting plates 22 project in the tire circumferential direction are opposite, and sizes thereof are the same.

With such a constitution, as shown in FIG. 3, in the case of shapes of the connecting members 15 in the side view of the tire, the connecting members 15 extend in the tire radial direction and are line symmetrical using an imaginary line L passing through the first ends 21a and 22a of the first connecting plates 21 and the second connecting plates 22 as an axis of symmetry.

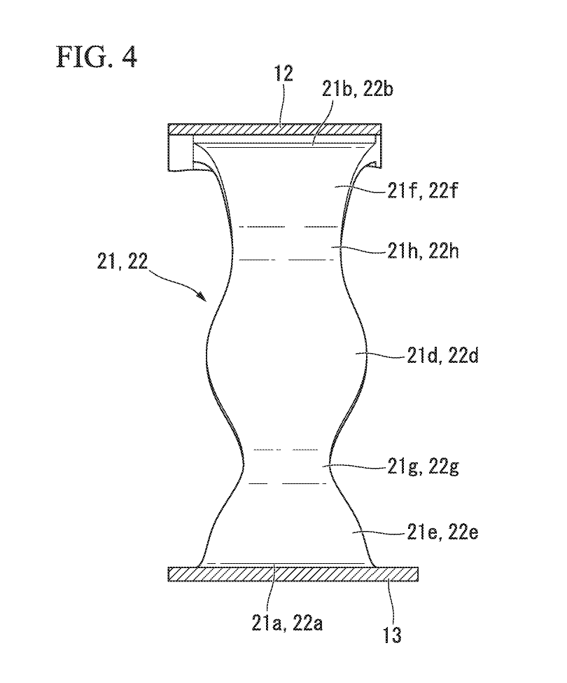

Note that, as shown in FIG. 4, inflection parts 21g, 21h, 22g, and 22h are formed at portions of the first connecting plates 21 and the second connecting plates 22 which are located between the curved parts 21d to 21f and 22d to 22f adjacent to each other in the extension directions of the connecting plates 21 and 22.

Areas of cross sections (cross-sectional areas) of the inflection parts 21g, 21h, 22g, and 22h in the first connecting plates 21 and the second connecting plates 22, which are orthogonal in the extension directions thereof, are formed to be smaller than those of other regions, and the inflection parts 21g, 21h, 22g, and 22h are located in boundary regions of the curved parts 21d to 21f and 22d to 22f adjacent to each other in the extension directions of the connecting plates 21 and 22.

In the shown example, the cross-sectional areas of the first connecting plates 21 and the second connecting plates 22 are formed to gradually decrease toward the inflection parts 21g, 21h, 22g, and 22h in the extension directions.

The exterior body 12, the ring-shaped body 13, and the plurality of connecting members 15, which have been described above, are integrally formed of, for example, a synthetic resin material. As the synthetic resin material, for example, only one type of a resin material, a mixture including two or more types of resin materials, or a mixture including one or more types of resin materials and one or more types of elastomers may be provided, and for example, an additive such as an antioxidant, a plasticizer, a filler, or a pigment may be further provided.

However, as shown in FIG. 1, the exterior body 12 is divided into a first exterior body 25 located at the first side in the tire width direction H and a second exterior body 26 located at the second side in the tire width direction H. Similarly, the ring-shaped body 13 is divided into a first ring-shaped body 23 located at the first side in the tire width direction H and a second ring-shaped body 24 located at the second side in the tire width direction H.

In the shown example, the exterior body 12 and the ring-shaped body 13 are divided at a central portion in the tire width direction H.

The first exterior body 25 and the first ring-shaped body 23 are integrally formed with the first connecting plates 21 using, for example, injection molding. The second exterior body 26 and the second ring-shaped body 24 are integrally formed with the second connecting plates 22 using, for example, injection molding.

Hereinafter, a unit in which the first exterior body 25, the first ring-shaped body 23, and the first connecting plates 21 are integrally formed is referred to as a first divided case body 31, and a unit in which the second exterior body 26, the second ring-shaped body 24, and the second connecting plates 22 are integrally formed is referred to as a second divided case body 32.

Note that, as the injection molding, if the first divided case body 31 is exemplified, a general method in which the entire first divided case body 31 is formed at the same time, insert molding in which a portion of the first exterior body 25, the first ring-shaped body 23, and the first connecting plates 21 is set as an insert article and the remaining portion is subject to injection molding, so-called two color molding, and the like may be adopted. Note that, when the entire first divided case body 31 is subject to injection molding at the same time, the plurality of ridge parts 12a formed at the exterior body 12 may be set as gate parts.

With regard to these points, the same applies to the second divided case body 32.

At a time of the injection molding, if the first divided case body 31 is exemplified, the first exterior body 25, the first ring-shaped body 23, and the first connecting plates 21 may be formed of different materials or may be formed of the same material. Examples of the material include a metallic material, a resinous material, and the like. However, a resinous material, particularly, a thermoplastic resin, is preferable from the viewpoint of weight reduction. With regard to these points, the same applies to the second divided case body 32.

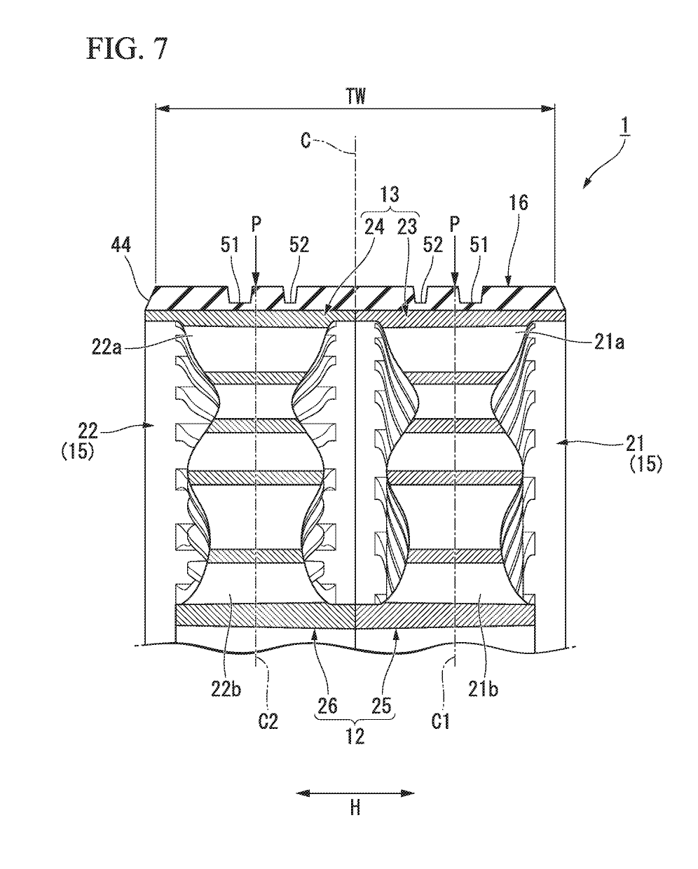

As shown in FIG. 7, central portions (a first connecting plate central plane C1 and a second connecting plate central plane C2) of the first connecting plates 21 and the second connecting plates 22 in the tire width direction H in the first divided case body 31 and the second divided case body 32 (central sides) are located further inward in the tire width direction H than central portions of the first ring-shaped body 23 and the second ring-shaped body 24 in the tire width direction H. Furthermore, central portions of the first exterior body 25 and the second exterior body 26 in the tire width direction H are located further inward in the tire width direction H than the central portions (the first connecting plate central plane C1 and the second connecting plate central plane C2) of the first connecting plates 21 and the second connecting plates 22 in the tire width direction H.

Here, the present invention is not limited thereto. In addition, at least two or more central portions of the central portions (the first connecting plate central plane C1 and the second connecting plate central plane C2) of the first connecting plates 21 and the second connecting plates 22 in the tire width direction H, the central portions of the first ring-shaped body 23 and the second ring-shaped body 24 in the tire width direction H, and the central portions of the first exterior body 25 and the second exterior body 26 in the tire width direction H may coincide with each other in the first divided case body 31 and the second divided case body 32.

Note that the above-described first connecting plate central plane (a connecting member central plane) C1 is a virtual plane passing through the centers of the first connecting plates 21 in the tire width direction H and orthogonal to the axis O in a cross-sectional view in the tire width direction H shown in FIG. 7, and the above-described second connecting plate central plane (a connecting member central plane) C2 is a virtual plane passing through the centers of the second connecting plates 22 in the tire width direction H and orthogonal to the axis O in the cross-sectional view in the tire width direction H.

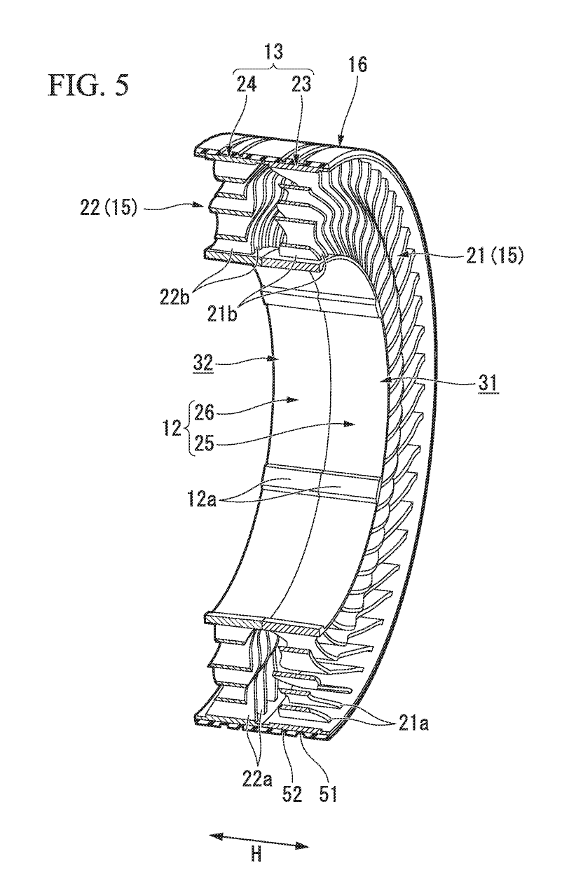

As shown in FIG. 5, edges of the first ring-shaped body 23 and the second ring-shaped body 24 which face each other in the tire width direction H are connected using, for example, welding, fusing, adhering, or the like. Note that, in the case of welding, for example, hot plate welding or the like may be adopted. Similarly, edges of the first exterior body 25 and the second exterior body 26 which face each other in the tire width direction H are in contact with each other.

Here, the first exterior body 25 and the second exterior body 26 may be formed to be smaller in width in the tire width direction H than those of the first ring-shaped body 23 and the second ring-shaped body 24.

In this case, the edges of the first exterior body 25 and the second exterior body 26 which face each other in the tire width direction H are separated in the tire width direction H at a time at which the first divided case body 31 and the second divided case body 32 are connected. Therefore, for example, a burr can be prevented from being generated at the inner circumferential surface of the exterior body 12 externally fitted to the mounting body 11.

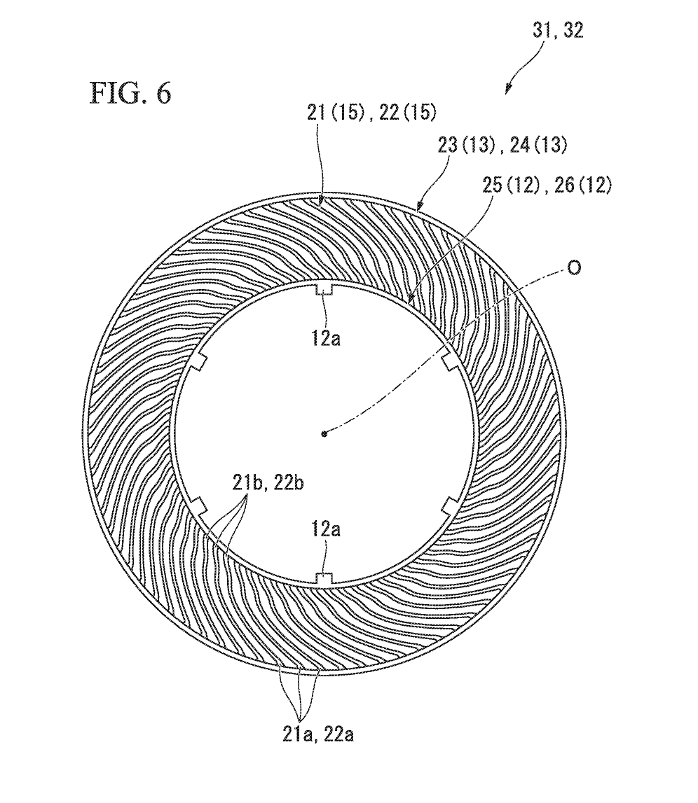

As shown in FIG. 6, the first divided case body 31 and the second divided case body 32 have the same shape and size. Also, when the first divided case body 31 and the second divided case body 32 are integrally connected as described above, the edges of the first ring-shaped body 23 and the second ring-shaped body 24 in the tire width direction H abut and are connected in a state in which directions of the first divided case body 31 and the second divided case body 32 are opposite to each other while the first divided case body 31 and the second divided case body 32 are aligned in the tire circumferential direction such that the connecting members 15 are line symmetrical in the side view of the tire as described above.

After that, the non-pneumatic tire 1 can be obtained by providing the tread member 16 to the first divided case body 31 and the second divided case body 32 which are integrally combined.

As shown in FIG. 5, the tread member 16 is formed in a cylindrical shape and integrally covers an outer peripheral surface side of the ring-shaped body 13 over the entire area thereof. The tread member 16 is formed of, for example, vulcanized rubber in which natural rubber and/or a rubber composition are/is vulcanized, a thermoplastic material, or the like.

Examples of the thermoplastic material include a thermoplastic elastomer, a thermoplastic resin, and the like. Examples of the thermoplastic elastomer include an amide-based thermoplastic elastomer (TPA), an ester-based thermoplastic elastomer (TPC), an olefin-based thermoplastic elastomer (TPO), a styrene-based thermoplastic elastomer (TPS), a urethane-based thermoplastic elastomer (TPU), a crosslinked thermoplastic rubber (TPV), another thermoplastic elastomer (TPZ), and the like which are defined in Japanese Industrial Standards JIS K6418.

Examples of the thermoplastic resin include urethane resins, olefin resins, vinyl chloride resins, polyamide resins, and the like. Note that the tread member 16 is preferably formed of vulcanized rubber from the viewpoint of wear resistance.

The tread member 16 will be described in detail.

An outer peripheral surface of the tread member 16 is formed in a linear shape (a flat shape) parallel to the axis O in a cross-sectional view in the tire width direction H shown in FIG. 7. In other words, the outer peripheral surface of the tread member 16 has a cylindrical surface shape about the axis O when the entire non-pneumatic tire 1 is viewed. Note that an inner circumferential surface of the tread member 16 is in close contact with the outer peripheral surface of the ring-shaped body 13 over the entire area thereof.

In this embodiment, the outer peripheral surface of the tread member 16 passes through the center of the tread member 16 in the tire width direction H in the cross-sectional view in the tire width direction H and is formed to be line symmetrical with respect to (about) a central plane (a central plane of the tire) C serving as a virtual plane orthogonal to the axis O. Furthermore, the outer peripheral surface of the tread member 16 is formed to be plane symmetrical with respect to the central plane C when the entire non-pneumatic tire 1 is viewed.

Here, the outer peripheral surface of the tread member 16 refers to a surface facing an outside of the tread member 16 in the tire radial direction. Furthermore, a portion of the outer peripheral surface of the tread member 16 that comes into contact with a road surface is a tread. Surfaces of the outer peripheral surface of the tread member 16 in the tire width direction H which are located further outward in the tire width direction H than outer edges (shoulder edges) thereof are side surfaces 44 configured to connect the outer peripheral surface of the tread member 16 and the ring-shaped body 13 and not serving as a tread.

The side surfaces 44 in the shown example incline gradually inward in the tire width direction H as they go outward in the tire radial direction. Therefore, the entire tread member 16 is within an inner side of the ring-shaped body 13 in the tire width direction H. In other words, the outer edges (portions of the side surfaces 44 which are located at outer sides in the tire radial direction) of the tread member 16 in the tire width direction H are the same as the outer edges of the ring-shaped body 13 in the tire width direction H at positions in the tire width direction H. Therefore, the tread member 16 does not protrude more toward the outer sides in the tire width direction H than the ring-shaped body 13.

Note that shapes of the side surfaces 44 are not limited to inclined surfaces. In addition, for example, the shapes may be curved surfaces or may be vertical surfaces extending in the tire radial direction and orthogonal to the axis O.

Also, grooves 51 and 52 that are concave from the outer peripheral surface are formed at an outer peripheral surface of a portion located above and corresponding to a portion of the tread member 16 at which the ring-shaped body 13 and the connecting member 15 are connected. In this embodiment, the plurality of grooves 51 and 52 extend in the outer peripheral surface of the tread member 16 in the tire circumferential direction and are formed at the outer peripheral surface of the tread member 16 at intervals in the tire width direction H.

In the example of FIG. 7, the plurality of grooves 51 and 52 are formed at an outer peripheral surface of a portion of the tread member 16 which is located above and corresponding to a portion of the ring-shaped body 13 at which the first and second connecting plates 21 and 22 are connected.

Groove depths of the grooves 51 and 52 in the tire radial direction are the same, and groove widths thereof in the tire width direction H are different. In the shown example, the groove width of the grooves 51 located at the outer sides in the tire width direction H among the grooves 51 and 52 is larger than the groove width of the grooves 52 located at the inner side in the tire width direction H.

Also, the groove widths of the grooves 51 and 52 gradually increase from groove bottoms toward opening sides (that is, outward in the tire radial direction) of the grooves. To be specific, a pair of lateral walls (inner walls of the grooves) of the grooves 51 and 52 are formed as inclined surfaces which are gradually separated in the tire width direction H from the groove bottoms toward the opening sides of the grooves.

Here, an arrow represented by reference symbol P in FIG. 7 indicates a point at which a ground contact pressure occurring at the tread member 16 is maximized when the grooves 51 and 52 are not formed at the tread member 16.

In this embodiment, the outer peripheral surface of the tread member 16 has a flat shape (a cylindrical surface shape) of which an outer diameter does not change over the entire area in the tire width direction H. Thus, the number of maximum points P is two, that is, a position passing through the centers of the first connecting plates 21 in the tire width direction H and located above the central plane (the first connecting plate central plane) C1 orthogonal to the axis O and a position passing through the centers of the second connecting plates 22 in the tire width direction H and located above the central plane (the second connecting plate central plane) C2.

Also, positions of the grooves 51 and 52 in the tire width direction H in the outer peripheral surface of the tread member 16 are set to correspond to the maximum points P (hereinafter simply referred to as “points P” in some cases) of the ground contact pressure occurring at the tread member 16.

In this embodiment, even sets of grooves 51 and 52 are formed at the outer peripheral surface of the portion of the tread member 16 which is located above and corresponding to the portion of the ring-shaped body 13 at which the first and second connecting plates 21 and 22 are connected. In addition, the grooves 51 and 52 are disposed to be shifted from positions above the points P in the tire width direction H to surround the points P (the first connecting plate central plane C1 and the second connecting plate central plane C2 in this embodiment) in the tire width direction H. Here, the present invention is not limited thereto. In addition, any of the grooves 51 and 52 may be disposed above the points P.

Note that, in the shown example, the grooves 51, which have a relatively larger groove width, of the plurality of grooves 51 and 52, which are provided at the outer peripheral surface of the corresponding portion, are disposed closer to the points P than the grooves 52, which have a relatively smaller groove width.

The number, shapes, and disposition of the grooves 51 and 52 provided in the outer peripheral surface of the tread member 16 are not limited to the number, the shapes, and the disposition described in this embodiment. For example, only one set of grooves 51 and 52 may be provided in the outer peripheral surface of the corresponding portion of the tread member 16, or three or more sets of grooves 51 and 52 may be provided. Note that, when odd sets of grooves 51 and 52 are provided in the outer peripheral surface of the corresponding portion, grooves located at centers in the tire width direction H among the grooves 51 and 52 are preferably disposed at positions above the points P in some cases. In other words, for example, when three sets of grooves 51 and 52 are provided in the outer peripheral surface of the corresponding portion at intervals in the tire width direction H, a set of grooves 51 and 52 located at a center among the three sets of grooves 51 and 52 are preferably disposed at positions above the points P in some cases. Here, also in this case, the grooves 51 and 52 may not be disposed above the points P.

The ratio of a total sum of the groove widths of the plurality of grooves 51 and 52 to a total width (a full width in the tire width direction H) TW of the outer peripheral surface of the tread member 16 is preferably within a range of 1/0 to 2/5.

### (Action of Non-Pneumatic Tire)

According to the non-pneumatic tire 1 constituted as described above, since the grooves 51 and 52 are formed at the outer peripheral surface of the corresponding portion of the tread member 16 in which the ground contact pressure is larger than an average ground contact pressure (a value obtained by dividing a load imposed on the tire by a ground contact area), the ground contact pressure occurring at such a portion can be reduced, and thus uneven wear of the tread member 16 can be limited.

In other words, the grooves 51 and 52 are formed so that the ground contact pressure is distributed to a portion other than the grooves 51 and 52 of the tread member 16, and thus variation of a magnitude of the ground contact pressure occurring at the tread member 16 is limited and the ground contact pressure is equalized. For this reason, an increase in a localized ground contact pressure of the tread member 16 is minimized, and thus uneven wear of the tread member 16 is limited.

In this embodiment, since the ratio of the total sum of the groove widths of the plurality of grooves 51 and 52 to the total width TW of the outer peripheral surface of the tread member 16 is 1/10 to 2/5, the ground contact pressure occurring at the tread member 16 can be efficiently distributed in the tire width direction H and is limited so that the ground contact pressure of the tread member 16 becomes too high as a whole (the average ground contact pressure becomes too large), and thus the tread member 16 is worn out early.

To be specific, an effect in which the ground contact pressure of the tread member 16 is distributed through the grooves 51 and 52 is not easily obtained when the ratio is less than 1/10, and thus uneven wear is likely to occur.

Also, the ground contact area of the tread member 16 is not easily sufficiently secured and the average ground contact pressure becomes large when the ratio is more than 2/5, and thus the tread member 16 is likely to be worn out early.

### Modified Example of First Embodiment

In the above-described first embodiment, the outer peripheral surface of the tread member 16 may be formed in a shape protruding outward in the tire radial direction in the cross-sectional view in the tire width direction H.

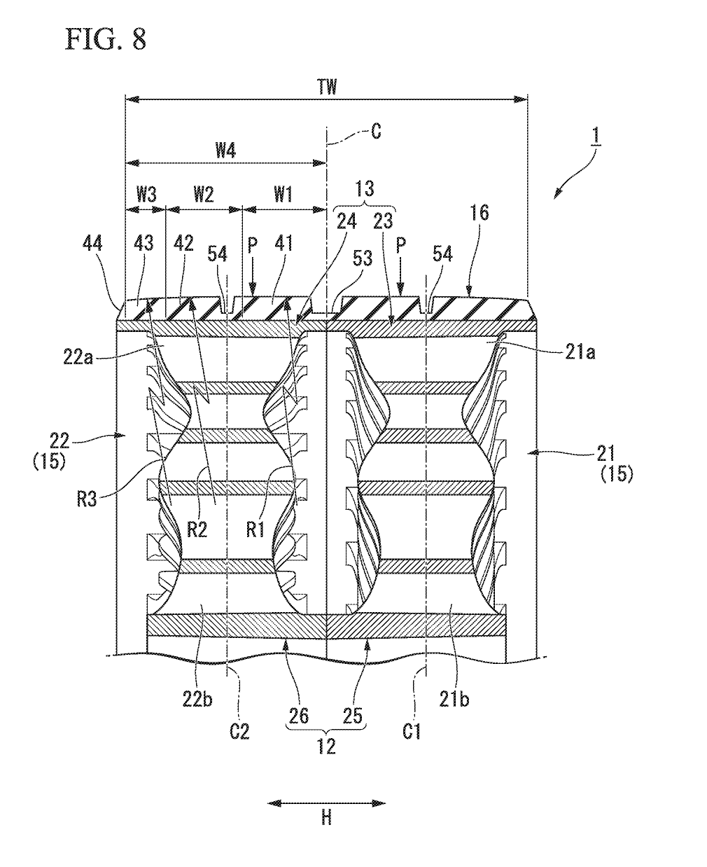

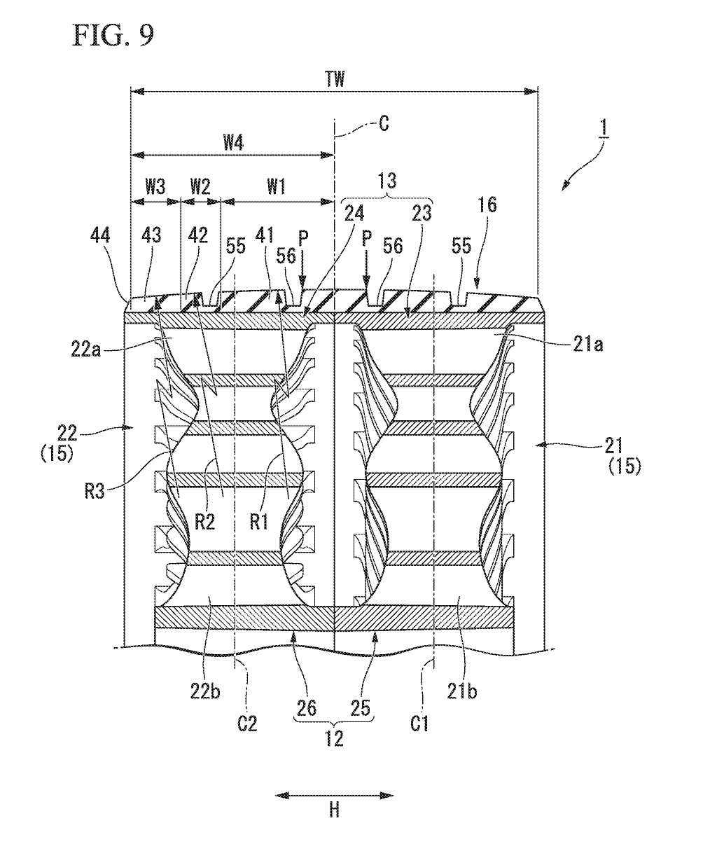

FIGS. 8 and 9 show a modified example of the first embodiment.

In the example shown in FIGS. 8 and 9, a plurality of curved surface parts 41 to 43 of an outer peripheral surface of a tread member 16 are connected to each other in a tire width direction H with no step therebetween and are formed in shapes protruding outward in a tire radial direction in a cross-sectional view in the tire width direction H. To be specific, the outer peripheral surface of the tread member 16 is formed in a curved surface shape formed to project outward in the tire radial direction when an entire non-pneumatic tire 1 is viewed.

The outer peripheral surface of the tread member 16 is constituted of three curved surface parts: central curved surface parts 41 located at central portions in the tire width direction H, shoulder curved surface parts 43 located at outer sides in the tire width direction H, and intermediate curved surface parts 42 located between the central curved surface parts 41 and the shoulder curved surface parts 43.

The central curved surface parts 41, the shoulder curved surface parts 43, and the intermediate curved surface parts 42 are formed to have different radii of curvatures R1 to R3 in the cross-sectional view in the tire width direction H, and virtual circles, which form portions (circular arcs) of circumferences, of the curved surface parts 41 to 43 are in contact with each other (inscribed or circumscribed) at portions at which the curved surface parts 41 to 43 are connected to each other. In other words, the circular arcs, which pass through the connection portions, of the curved surface parts 41 to 43 adjacent to each other in the tire width direction H at connection portions have common tangents at the connection portions in the cross-sectional view in the tire width direction H.

As described above, since the central curved surface parts 41, the shoulder curved surface parts 43, and the intermediate curved surface parts 42 are connected to each other in the tire width direction H with no step therebetween, as shown in FIGS. 8 and 9, the outer peripheral surface of the tread member 16 can be smoothly and continuously curved, and the entire outer peripheral surface can reliably come into contact with the ground.

Note that, although radius of the curvature R1 of the central curved surface parts 41, the radius of the curvature R2 of the intermediate curved surface parts 42, and the radius of the curvature R3 of the shoulder curved surface parts 43 have different radii of curvatures, in the example shown in FIG. 8, the radius of the curvature R2 of the intermediate curved surface parts 42 is the largest and the radius of the curvature R3 of the shoulder curved surface parts 43 is the smallest. Furthermore, in the example shown in FIG. 9, the radius of the curvature R3 of the shoulder curved surface parts 43 is the largest and the radius of the curvature R1 of the central curved surface parts 41 is the smallest.

If a length in the tire width direction H from a central plane C to a portion at which one of the central curved surface parts 41 and one of the intermediate curved surface parts 42 are connected is set to be a central length W1, the length in the tire width direction H from the portion at which the central curved surface part 41 and the intermediate curved surface part 42 are connected to a portion at which the intermediate curved surface part 42 and one of the shoulder curved surface parts 43 are connected is set to be an intermediate length W2, a length in the tire width direction H from the portion at which the intermediate curved surface part 42 and the shoulder curved surface part 43 are connected to a portion at which the shoulder curved surface part 43 and one of the side surfaces 44 are connected is set to be a shoulder length W3, and a length in the tire width direction H from the central plane C to the portion at which the shoulder curved surface part 43 and the side surface 44 are connected is set to be an overall length W4, in the example shown in FIG. 8, the intermediate length W2 is the largest and the shoulder length W3 is the smallest. Here, the intermediate length W2 and the central length W1 are substantially the same. Furthermore, in the example shown in FIG. 9, the central length W1 is the largest and the intermediate length W2 is the smallest. Here, the intermediate length W2 and the shoulder length W3 are substantially the same.

In FIGS. 8 and 9, the central length W1 is ⅔ or less the overall length W4.

Note that, although description is provided with respect to only half a region of the tread member 16 using the central plane C as a boundary in FIGS. 8 and 9, the same applies to the entire region of the tread member 16 with regard to a relationship between the above-described lengths.

In other words, a distance (the above-described central length WI) in the tire width direction H between the central plane C and an outer end (a first outer end) of the central curved surface part 41 in the tire width direction H is ⅔ or less of a distance (the above-described overall length W4) in the tire width direction H between the central plane C and an outer end (a second outer end) of the shoulder curved surface part 43 in the tire width direction H as in FIGS. 8 and 9.

Note that the above-described first outer end corresponds to the portion at which the central curved surface part 41 and the intermediate curved surface part 42 are connected. The above-described second outer end corresponds to the portion at which the shoulder curved surface part 43 and the side surface 44 are connected.

In the example shown in FIG. 8, grooves 53 are formed at an outer peripheral surface of a top part of the tread member 16 which is located closest to an outer side in the tire radial direction (a top part of the tread member 16 of which an outer diameter is maximal). To be specific, the above-described top part is located at a central portion of the tread member 16 in the tire width direction H. Note that, in the shown example, the grooves 53 are formed at an outer peripheral surface of a portion of the tread member 16 which is located above a gap between portions of the ring-shaped body 13 at which the first and second connecting plates 21 and 22 are connected.

In the example shown in FIG. 8, grooves 54 are formed at an outer peripheral surface of a portion of the tread member 16 which is located above and corresponding to a portion of the ring-shaped body 13 at which the first and second connecting plates 21 and 22 are connected. In the shown example, the grooves 54 are located above each of the first connecting plate central plane C1 and the second connecting plate central plane C2.

The grooves 53 and 54 of the tread member 16 have different groove depths in the tire radial direction and different groove widths in the tire width direction H. To be specific, positions of groove bottoms in the grooves 53 and 54 in the tire radial direction are the same, whereas positions of openings of the grooves in the tire radial direction are different. For this reason, the groove depth of the grooves 53 is slightly deeper than the groove depth of the grooves 54. Furthermore, the groove width of the grooves 53 located at the central portions in the tire width direction H among the grooves 53 and 54 is larger than the groove width of the grooves 54 located at outer sides in the tire width direction H.

The outer peripheral surface of the tread member 16 is formed in a shape protruding outward in the tire radial direction in the cross-sectional view in the tire width direction H. Thus, maximum points P of a ground contact pressure at the tread member 16 are disposed further inward in the tire width direction H than the first connecting plate central plane C1 and further inward in the tire width direction H than the second connecting plate central plane C2.

Note that amounts of displacement by which the points P are displaced further inward in the tire width direction H than the first and second connecting plate central planes C1 and C2 correspond to a rectangle rate of the outer peripheral surface of the tread member 16.

Here, “a rectangle rate” will be defined below. In other words, if a ground contact length in the tire circumferential direction above a tire equator is set to be Lc and ground contact lengths in the tire circumferential direction at positions directed toward the outer sides in the tire width direction H and 40% of a magnitude of a maximum ground contact width away from the tire equator are set to be La and Lb in a tread of the tread member 16 coming into contact with the ground when the non-pneumatic tire 1 is statically placed on a flat road surface under normal conditions, a rectangle rate of a ground contact shape of the tread is represented by the following expression.

Rectangle rate=100×(La+Lb)/2/Lc

Also, the amounts of displacement of the points P are increased when the rectangle rate is decreased.

In the example shown in FIG. 9, a plurality of grooves 55 and 56 are formed at the outer peripheral surface of the portion of the tread member 16 which is located above and corresponding to the portion of the ring-shaped body 13 at which the first and second connecting plates 21 and 22 are connected. In the shown example, the grooves 55 of the grooves 55 and 56 are disposed further outward in the tire width direction H than the first and second connecting plate central planes C1 and C2, and the grooves 56, which have deeper groove depths than the grooves 55, are disposed further inward in the tire width direction H than the first and second connecting plate central planes C1 and C2. Furthermore, groove widths of the grooves 55 and 56 are the same.

A rectangle rate of the tread member 16 of the non-pneumatic tire 1 shown in FIG. 9 is smaller than a rectangle rate of the tread member 16 of the non-pneumatic tire 1 shown in FIG. 8. For this reason, the points P in FIG. 9 are located further inward in the tire width direction H than the points P in FIG. 8.

Also in the case of the non-pneumatic tire 1 constituted in this way, since the grooves 53 to 56 are formed at the outer peripheral surface of the portion located above and corresponding to the portion of the tread member 16 at which the ring-shaped body 13 and the connecting members 15 are connected, the same action and effect as in the above-described action and effect can be obtained.

In the example shown in FIG. 8, since the grooves 53 are formed at the outer peripheral surface of the portion of the tread member 16 which is located above the gap between the portions of the ring-shaped body 13 at which the first and second connecting plates 21 and 22 are connected, gap of the ring-shaped body 13 of which strength is lower than that of other portions does not come into contact with the ground via the tread member 16, and thus a load applied to the gap can be minimized and durability of the non-pneumatic tire 1 (the ring-shaped body 13) can be improved.

Note that, as shown in FIG. 8, when the outer peripheral surface of the tread member 16 is formed in a shape protruding outward in the tire radial direction in the cross-sectional view in the tire width direction H, the ground contact pressure of the top part of the tread member 16 which is located closest to the outside in the tire radial direction easily becomes larger than the average ground contact pressure, but the grooves 53 are formed at the outer peripheral surface of the top part so that the ground contact pressure occurring at this portion can be reduced or uneven wear of the tread member 16 can be limited.

When the radius of the curvature R2 of the intermediate curved surface part 42 among the plurality of curved surface parts 41, 42, and 43 constituting the outer peripheral surface of the tread member 16 is the largest, the thickness of the central curved surface part 41 can be prevented from being excessively increased, and the central curved surface part 41 can be prevented from protruding significantly outward in the tire radial direction. Therefore, rigidity of the central curved surface part 41 can be prevented from decreasing, and thus manipulability can be improved and stability can be achieved.

When the central curved surface part 41 is located at the central portion of the outer peripheral surface of the tread member 16 in the tire width direction H and is connected to the intermediate curved surface part 42, which have the largest radius of curvature with no step, the central curved surface part 41 can project further outward in the tire radial direction than when the outer peripheral surface of the tread member 16 is formed to be flat in the cross-sectional view in the tire width direction H.

Therefore, since the central curved surface part 41 can actively come into contact with the ground and secure the ground contact length, a straight traveling stability is improved and manipulability is further improved. Furthermore, since a driver's reaction in the vicinity of neutral of a handle can be improved, for example, when a vehicle is steered, the manipulability can be stabilized.

### Second Embodiment

A second embodiment related to the present invention will be described.

The second embodiment is different from the first embodiment in that, while the first divided case body 31 and the second divided case body 32 divided in the tire width direction H are provided in the first embodiment, an exterior body 61, a ring-shaped body 62, and connecting members 63 are not divided in a tire width direction H and grooves 57 and 58 of a tread member 16 are different in the second embodiment.

Note that constituent elements of the second embodiment that are the same as those of the first embodiment are denoted with the same reference numerals, and descriptions thereof are omitted.

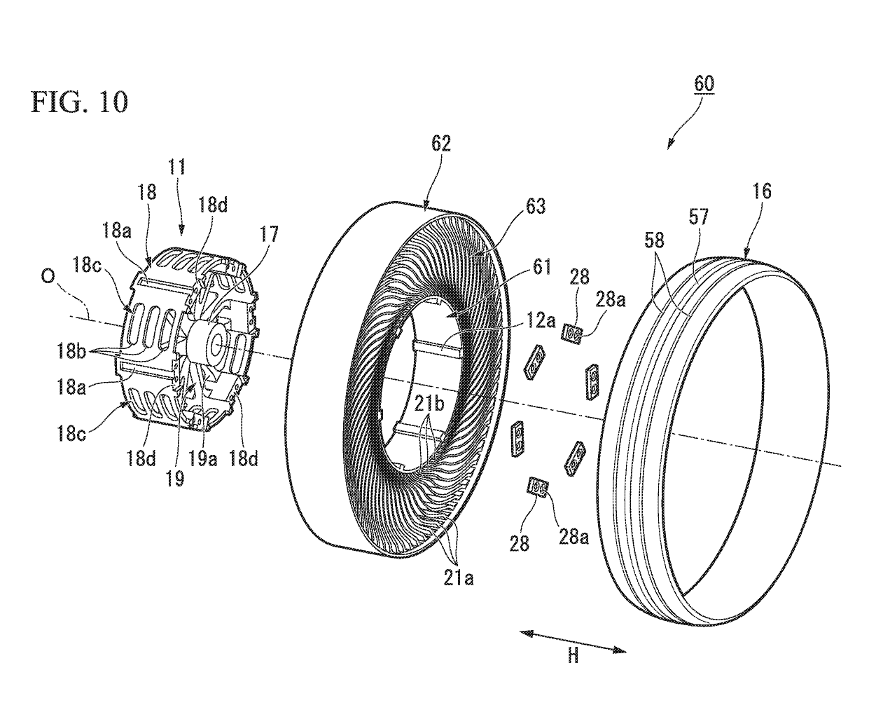

As shown in FIG. 10, a non-pneumatic tire 60 of this embodiment includes a mounting body 11, the exterior body 61, the ring-shaped body 62, the connecting members 63, and the tread member 16.

A width of the exterior body 61 in the tire width direction H is the same as that when the first exterior body 25 and the second exterior body 26 are connected in the first embodiment. Note that other points are the same as those of the first embodiment.

Similarly, a width of the ring-shaped body 62 in the tire width direction H is the same as that when the first ring-shaped body 23 and the second ring-shaped body 24 are connected in the first embodiment, and other points are the same as those of the first embodiment.

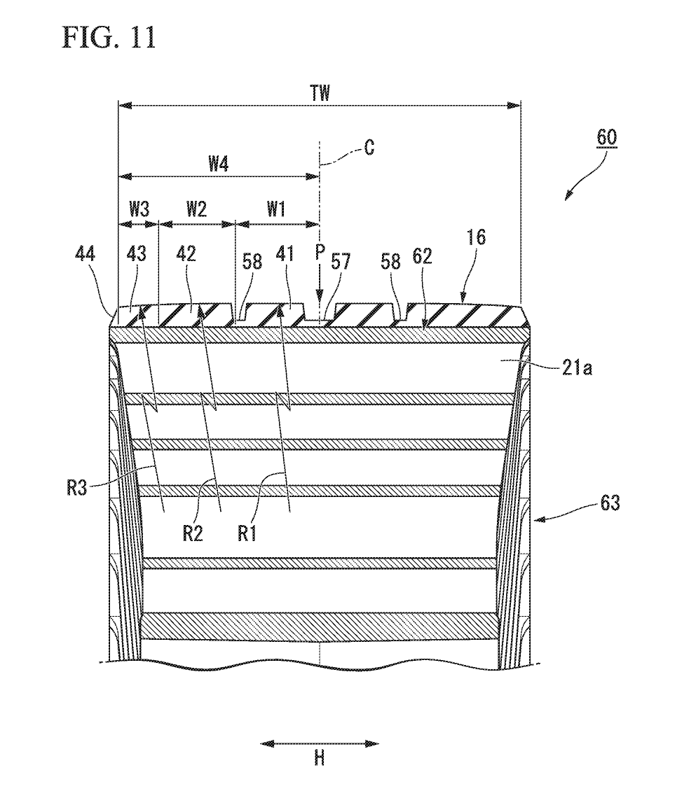

A width of the connecting members 63 in the tire width direction H is about twice the width of the first connecting plates 21 in the first embodiment, and other points are basically the same as those of the first embodiment. Here, as shown in FIG. 11, the connecting members 63 of this embodiment do not have a plurality of inflection parts, but have, for example, shapes of which widths gradually narrow from the first ends 21a and the second ends 21b toward central portions of extension directions of the connecting members 63. Here, the shapes of the connecting members 63 are not limited to this case, and may be appropriately changed.

An outer peripheral surface of the tread member 16 is formed in a shape protruding outward in a tire radial direction in a cross-sectional view in the tire width direction H. To be specific, as in the above-described modified example of the first embodiment, the outer peripheral surface of the tread member 16 is constituted by three curved surface parts: a central curved surface part 41, a shoulder curved surface part 43, and an intermediate curved surface part 42, and the curved surface parts 41 to 43 are formed to have different radii of curvatures R1 to R3 in the cross-sectional view in the tire width direction H.

Also, the plurality of grooves 57 and 58 are formed at an outer peripheral surface of a portion located above and corresponding to a portion of the tread member 16 at which the ring-shaped body 62 and the connecting members 63 are connected.

The grooves 57 of the grooves 57 and 58 are formed at an outer peripheral surface of a top part of the tread member 16 which is located closest to an outer side thereof in the tire radial direction.

To be specific, the grooves 57 are located at a central portion of the outer peripheral surface of the tread member 16 in the tire width direction H and are disposed at a central plane C. Note that, in this embodiment, a connecting member central plane (not shown) passing through centers of the connecting members 63 in the tire width direction H and orthogonal to the axis O coincides with the central plane C.

The grooves 58 are disposed between the central portion of the outer peripheral surface of the tread member 16 in the tire width direction H and both outer ends thereof.

Groove depths of the grooves 57 and 58 in the tire radial direction are different, and groove widths thereof in the tire width direction H are different. To be specific, the groove depth of the grooves 57 is slightly deeper than the groove depth of the grooves 58, and the groove width of the grooves 57 is larger than the groove width of the grooves 58.

According to the non-pneumatic tire 60 constituted in this way, the same action and effect as in the first embodiment can be accomplished.

Also, in this embodiment, the outer peripheral surface of the tread member 16 is formed in a shape protruding outward in the tire radial direction in the cross-sectional view in the tire width direction H. In addition, since the top part of the tread member 16 which is located closest to the outer side in the tire radial direction is above an outer peripheral surface of a portion located above and corresponding to a portion of the tread member 16 at which the ring-shaped body 62 and the connecting members 63 are connected, when the grooves 57 are not formed, a ground contact pressure of the above-described top part is significantly larger than an average ground contact pressure thereof.

To be specific, as shown in FIG. 11, when the grooves 57 are not formed at the tread member 16, a maximum point P of the ground contact pressure at the tread member 16 is above the central plane C.

Thus, in this embodiment, the grooves 57 are formed at the outer peripheral surface of the top part so that the ground contact pressure occurring at this portion can be reduced, the ground contact pressure is easily distributed equally in the tire width direction H, and thus uneven wear of the tread member 16 can be limited.

Note that the technical scope of the present invention is not limited to the embodiments, and various modifications are possible without departing from the gist of the present invention.

For example, although a case in which the outer peripheral surface of the tread member 16 is formed to be line symmetrical with respect to the central plane C in the cross-sectional view in the tire width direction H has been described in the above-described embodiments, the outer peripheral surface thereof may be asymmetrical.

Also, although a case in which the outer peripheral surface of the tread member 16 has a linear shape (a flat shape) in the cross-sectional view in the tire width direction H and a case in which the tread member 16 thereof is constituted by the three curved surface parts 41 to 43 having different radii of curvatures are exemplified in the above-described embodiments, the present invention is not limited thereto. For example, the outer peripheral surface of the tread member 16 may be formed to have a single circular arc (a curved surface part) in the cross-sectional view in the tire width direction H or may be formed to have two or four or more circular arcs (curved surface parts).

Although a constitution in which one first connecting plate 21 and one second connecting plate 22 are provided as the connecting member 15 is shown in the first embodiment, a plurality of first connecting plates 21 and a plurality of second connecting plates 22 may instead be provided at different positions of one connecting member 15 in the tire width direction H. The plurality of connecting members 15 are provided between the exterior body 12 and the ring-shaped body 13 in the tire width direction H.

Unlike the first embodiment, for example, the second ends 21b and 22b of the first connecting plates 21 and the second connecting plates 22 may be separately connected to positions of the outer peripheral surface of the exterior body 12 which surround the axis O in the tire radial direction and are opposite to each other, or may be connected to positions or the like of the outer peripheral surface of the exterior body 12 which are opposite to the first ends 21a and 22a of the first connecting plates 21 and the second connecting plates 22 in the tire radial direction. Furthermore, unlike the first embodiment, the first ends 21a and 22a of the first connecting plates 21 and the second connecting plates 22 may be connected to different positions of the inner circumferential surface of the ring-shaped body 13 in the tire circumferential direction.

Also, in the first embodiment, a gap may or may not be provided between the first exterior body 25 and the second exterior body 26 in the tire width direction H. The exterior body 12 and the ring-shaped body 13 may or may not be divided into three or more pieces in the tire width direction H.

Although the exterior body 12 or 61, the ring-shaped body 13 or 62, and the connecting member 15 or 63 are formed integrally using, for example, injection molding in the above-described embodiments, the present invention is not limited to injection molding, and the exterior body 12 or 61, the ring-shaped body 13 or 62, and the connecting member 15 or 63 may be formed integrally using, for example, casting or the like. Furthermore, the exterior body 12 or 61, the ring-shaped body 13 or 62, and the connecting member 15 or 63 may be connected to each other after being individually formed.

The exterior body 12 or 61 and the mounting body 11 may be formed integrally. In other words, the exterior body 12 or 61 may be included in the mounting body 11.

Although the connecting member 15 or 63 is indirectly connected to the mounting body 11 via the exterior body 12 or 61 in the above-described embodiments, the present invention is not limited thereto, and may be, for example, constituted to directly connect the connecting member 15 or 63 to the mounting body 11.

In addition, the constitutions (constituent elements) described in the above-described embodiments, modified examples, provisos, and the like may be combined without departing from the gist of the present invention. Also, addition, omission, substation, and other modification of a constitution are possible. The present invention is not limited to the embodiments, and is only limited by the scope of the appended claims.

### INDUSTRIAL APPLICABILITY

According to the present invention, variation of a magnitude of a ground contact pressure occurring at a tread member can be minimized and equalized. Thus, a non-pneumatic tire which suppresses uneven wear of a tread member can be provided.

### REFERENCE SIGNS LIST

1, 60 Non-pneumatic tire
11 Mounting body
13, 62 Ring-shaped body
15, 63 Connecting member
16 Tread member
21 First the connecting plate
22 Second connecting plate
51 to 58 Grooves
H Tire width direction
TW Total width of the outer peripheral surface of tread member

What is claimed is:

1. A non-pneumatic tire comprising:
a mounting body mounted on an axle;
a ring-shaped body surrounding the mounting body from an outside in a tire radial direction;
a connecting member configured to connect the mounting body and the ring-shaped body such that the mounting body and the ring-shaped body are displaceable; and
a cylindrical tread member mounted over the ring-shaped body,
wherein grooves are formed at an outer peripheral surface of a portion located above and corresponding to a portion of the tread member at which the ring-shaped body and the connecting member are connected.

2. A non-pneumatic tire comprising:
a mounting body mounted on an axle;
a ring-shaped body surrounding the mounting body from an outside in a tire radial direction;
a connecting member configured to connect the mounting body and the ring-shaped body such that the mounting body and the ring-shaped body are displaceable; and
a cylindrical tread member mounted over the ring-shaped body,
wherein an outer peripheral surface of the tread member is formed in a shape protruding outward in the tire radial direction in a cross-sectional view in a tire width direction, and
grooves are formed at an outer peripheral surface of a top part of the tread member which is located closest to an outer side in the tire radial direction.

3. The non-pneumatic tire according to claim 1, wherein the plurality of grooves extend in a tire circumferential direction and are formed at intervals in the tire width direction, and
a ratio of a total sum of groove widths of the plurality of grooves to a total width of an outer peripheral surface of the tread member is 1/10 to 2/5.

4. The non-pneumatic tire according to claim 2, wherein the plurality of grooves extend in a tire circumferential direction and are formed at intervals in the tire width direction, and
a ratio of a total sum of groove widths of the plurality of grooves to a total width of the outer peripheral surface of the tread member is 1/10 to 2/5.

5. The non-pneumatic tire according to claim 1, wherein the connecting member includes a first connecting plate and a second connecting plate arranged at intervals in the tire width direction, and
grooves are formed at an outer peripheral surface of a portion of the tread member which is located above a gap between portions of the ring-shaped body at which the first and second connecting plates are connected.

6. The non-pneumatic tire according to claim 2, wherein the connecting member includes a first connecting plate and a second connecting plate arranged at intervals in the tire width direction, and
grooves are formed at an outer peripheral surface of a portion of the tread member which is located above a gap between portions of the ring-shaped body at which the first and second connecting plates are connected.

7. The non-pneumatic tire according to claim 3, wherein the connecting member includes a first connecting plate and a second connecting plate arranged at intervals in the tire width direction, and
grooves are formed at an outer peripheral surface of a portion of the tread member which is located above a gap between portions of the ring-shaped body at which the first and second connecting plates are connected.

8. The non-pneumatic tire according to claim 4, wherein the connecting member includes a first connecting plate and a second connecting plate arranged at intervals in the tire width direction, and
grooves are formed at an outer peripheral surface of a portion of the tread member which is located above a gap between portions of the ring-shaped body at which the first and second connecting plates are connected.
